(19) United States
(12) Patent Application Publication
(10) Pub. No.: US 2013/0083940 A1
(43) Pub. Date: Apr. 4, 2013

(54) Bone Conduction Earphone, Headphone and Operation Method of Media Device Using the Same

(71) Applicant: Sung Jae Hwang, Daejeon (KR)

(72) Inventor: Sung Jae Hwang, Daejeon (KR)

(73) Assignee: KOREA ADVANCED INSTITUTE OF SCIENCE AND TECHNOLOGY, Daejeon (KR)

(21) Appl. No.: 13/699,164

(22) PCT Filed: May 26, 2011
(86) PCT No.: PCT/KR11/03860

§ 371 Date: Dec. 11, 2012

(30) Foreign Application Priority Data
May 26, 2010 (KR) 10-2010-0048900

(51) Int. Cl. H04R 1/10

(52) U.S. Cl. CPC H04R 1/1041
USPC 381/74

(57) ABSTRACT

Provided are a bone conduction-based earphone, a bone conduction-based headphone and a method for operating a medium device using the same.

The bone conduction-based earphone includes: a bone conduction sensor for detecting a sound transferred through the bone; and a controller for manipulating a medium device connected to the earphone in response to the pattern of the sound detected by the sensor. The earphone or headphone transfers an air conduction sound received from a medium device and a bone conduction sound generated from the collision of teeth of a person together in an independent manner. By doing this, a user may effectively control the medium device by means of the bone conduction sound generated by the collision of teeth while receiving sound information such as music. Therefore, the user may effectively manipulate or control the medium device by using the teeth instead of the hand.

### TECHNICAL FIELD

This disclosure relates to a bone conduction-based earphone, a bone conduction-based headphone and a method for operating a medium device using the same, and more particularly, to a bone conduction-based earphone, a bone conduction-based headphone and a method for operating a medium device using the same, which may effectively control the medium device according to a bone conduction sound generated from the collision of teeth of a person.

### BACKGROUND ART

Generally, vibrations of the sound transmitted through the air are transferred to the eardrum in the ear. Three bones (ossicles) are present in the eardrum, and the vibrations of the eardrum are transferred to a cochlea with a snail shape through these bones. The cochlea is filled with fluid, and vibrations of the fluid are converted into electric signals and transferred to the auditory nerves. By doing so, the brain of a person recognizes sounds. The bone conduction skips the process that vibrations pass via the eardrum and the auditory ossicles at the sound recognition mechanism. In other words, sound vibrations are directly sent to the cochlea through the cranium. Therefore, a person who has difficulty in hearing due to the abnormality in the auditory ossicles may clearly hear sounds by means of bone conduction if the cochlea or the auditory nerves is proper. An earphone using this principle is a bone conduction earphone generally used in the art. If such bone conduction is used, sounds are transferred in a different way from a sound transferring mechanism using air conduction which uses the air as a medium. At present, various kinds and shapes of bone conduction earphones are being developed.

For example, Korean Unexamined Patent Publication No. 10-2008-0015185 and Korean Unexamined Patent Publication No. 10-2007-0105555 disclose an earphone using the bone conduction effect. However, the conventional bone conduction earphones are focused on how to effectively transfer sounds to a user. Therefore, a method for a user to control a sound device or the like by using bone conduction sounds in a peculiar frequency band available not only in the sound device but also in a body of a person is not yet disclosed.

### DISCLOSURE

### [Technical Problem]

This disclosure is directed to providing a new-concept bone conduction-based earphone or headphone, which may control a medium device or the like by means of bone conduction sounds generated from the collision of teeth of a person.

This disclosure is also directed to providing a new-concept method for operating a medium device, which allows to control a medium device or the like by means of the collision of teeth of a person instead of using the hand.

### [Technical Solution]

In one general aspect, there is provided a bone conduction-based earphone, which includes: a bone conduction sensor for detecting a sound transferred through the bone; and a controller for manipulating a medium device connected to the earphone in response to the pattern of the sound detected by the sensor.

According to an embodiment of the present disclosure, the sound may be generated from the collision of teeth of a user, and the bone conduction sensor may have at least two channels to induce an improved recognition rate.

According to another embodiment of the present disclosure, the earphone may further include a filtering unit for filtering frequency bands other than a frequency band of the sound generated from the collision of teeth.

According to another embodiment of the present disclosure, the earphone may be worn on the head in a headphone type.

According to another embodiment of the present disclosure, there is also provided an earphone connectable to a medium device and inserted into the ear of a person, which includes: a first unit for generating an air conduction sound in response to an electric signal generated from the medium device; and a second unit for detecting a bone conduction sound transmitted through the bone, the second unit manipulating the medium device according to a pattern of the transferred bone conduction sound.

According to an embodiment of the present disclosure, the first unit may include: a magnet for forming an electric field according to the electric signal from the medium device; and a vibration plate vibrating according to the formed electric field.

The second unit may include: a sensor for detecting a bone conduction sound generated from the collision of teeth of a user; a calculator for comparing the bone conduction sound pattern detected by the sensor with a preset sound pattern; and a controller for manipulating the connected medium device by generating a command signal allocated to the preset sound pattern, in the case the detected bone conduction sound pattern is determined as the preset sound pattern.

According to an embodiment of the present disclosure, the sensor may be provided in an earphone housing which allows the earphone contacts the ear of a person, and the bone conduction sound pattern may be distinguished according to the frequency of collisions of teeth and the location of collision.

In another aspect, there is provided a headphone connectable to a medium device and worn on the head of a person, which includes: a first unit for generating an air conduction sound in response to an electric signal generated from the medium device; and a second unit for detecting a bone conduction sound transmitted through the bone, the second unit manipulating the medium device according to a pattern of the transferred bone conduction sound.

The first unit may include: a magnet for forming an electric field according to the electric signal from the medium device; and a vibration plate vibrating according to the formed electric field. The second unit may include: a sensor for detecting a bone conduction sound generated from the collision of teeth of a user; a calculator for comparing the bone conduction sound pattern detected by the sensor with a preset sound pattern; and a controller for manipulating the connected medium device by generating a command signal allocated to the preset sound pattern, in the case the detected bone conduction sound pattern is determined as the preset sound pattern.

In another aspect, there is provided a method for operating a medium device by using an earphone or headphone, which includes: detecting a bone conduction sound by using a bone conduction sensor provided at the earphone or headphone; comparing the detected sound pattern with a preset sound pattern; generating a command signal allocated to the preset sound pattern, in the case the detected sound pattern is matched with the preset sound pattern; and manipulating the medium device according to the command signal. The bone conduction sound may be generated from the collision of teeth of a user.

### [Advantageous Effects]

The earphone or headphone according the present disclosure transfers an air conduction sound received from a medium device and a bone conduction sound generated from the collision of teeth of a person together. By doing this, a user may effectively control the medium device by means of the bone conduction sound generated by the collision of teeth while receiving sound information such as music. Therefore, the user may effectively manipulate or control the medium device by using the teeth instead of the hand.

### DESCRIPTION OF DRAWINGS

FIG. 1 is a block diagram showing an earphone according to an embodiment of the present disclosure.

FIG. 2 is a block diagram showing a bone conduction-based earphone having a filtering unit.

FIG. 3 is a block diagram showing an earphone according to an embodiment of the present disclosure.

FIG. 4 is a schematic view showing an earphone according to an embodiment of the present disclosure.

FIG. 5 is a block diagram showing a headphone according to an embodiment of the present disclosure,

FIG. 6 is a schematic view showing a headphone according to the present disclosure.

FIG. 7 is a flowchart for illustrating a method for operating a medium device by using the earphone or headphone.

### BEST MODE

In order to sufficiently understand the present invention, advantages in operations of the present invention and objects accomplished by the implementation of the present invention, accompanying drawings which exemplarily show preferred embodiments of the present invention and contents depicted in the accompanying drawings should be referred to.

Hereinafter, preferred embodiments of the present invention will be described with reference to the accompanying drawings to illustrate the present invention in detail. However, the present invention may be implemented in various different ways, without being limited to the following embodiments. In addition, in order to clearly describe the present invention, explanations extrinsic to the essential features of the present invention will be omitted, and the same reference symbol in the drawings represents the same component.

In the entire specification, when expressing that any part “includes” a component, it means that the part can further include another component, without excluding other components, if not otherwise indicated. In addition, the terms such as “. . . unit”, “. . . portion”, “module” and “block” used in the specification means a unit which performs at least one function or operation, and it can be implemented as a hardware or software, or a combination thereof.

The present disclosure provides an earphone, a headphone or the like, which allows to manipulate or control a medium device by using a bone conduction sound generated from the collision of teeth of a person while transferring a sound from the medium device, different from a conventional earphone focused on the transfer of sound from a medium device (MP3, a smart phone or the like).

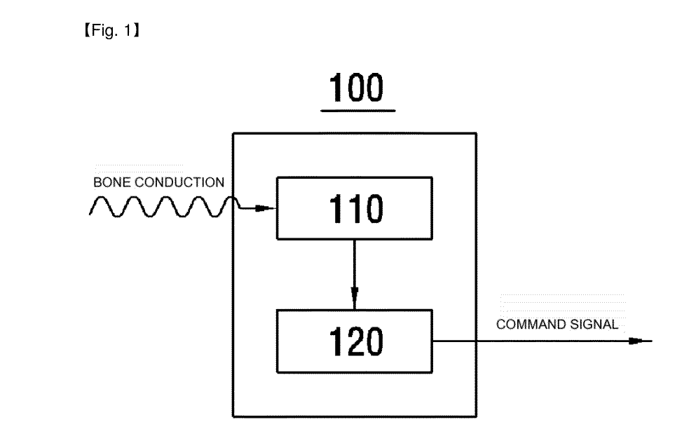

FIG. 1 is a block diagram showing an earphone according to an embodiment of the present disclosure.

Referring to FIG. 1, an earphone 100 according to the present disclosure includes a sensor 110 for detecting a bone conduction sound, and a controller 120 for manipulating a medium device connected to the earphone in response to the pattern of the sound detected by the sensor. The earphone 100 further includes units for transferring an air conduction sound according to an electric signal received from the medium device, which will be described in detail later.

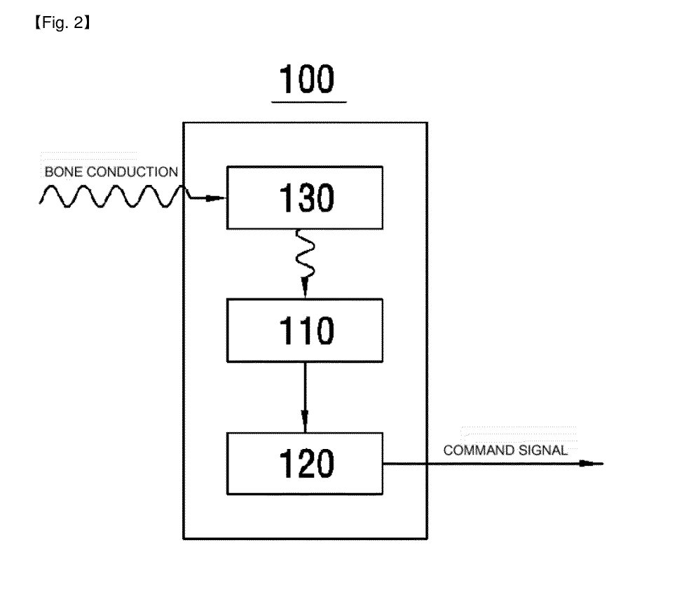

In the embodiment of the present disclosure, the bone conduction sound is generated from the collision of teeth of a user, without being limited thereto. The earphone according to the present disclosure may further include a filtering unit for filtering frequency bands other than a frequency band of the sound generated from the collision of teeth, and FIG. 2 is a block diagram showing a bone conduction-based earphone having the filtering unit.

Referring to FIG. 2, in the bone conduction sounds transmitted from the earphone 100 according to the present disclosure, the filtering unit 130 removes bone conduction sounds in frequency bands other than the frequency band required for manipulating and controlling the medium device. The bone conduction-based sound device according to the present disclosure may be in the form of an earphone or a headphone.

### MODE FOR INVENTION

Hereinafter the earphone according to an embodiment of the present disclosure will be described in more detail.

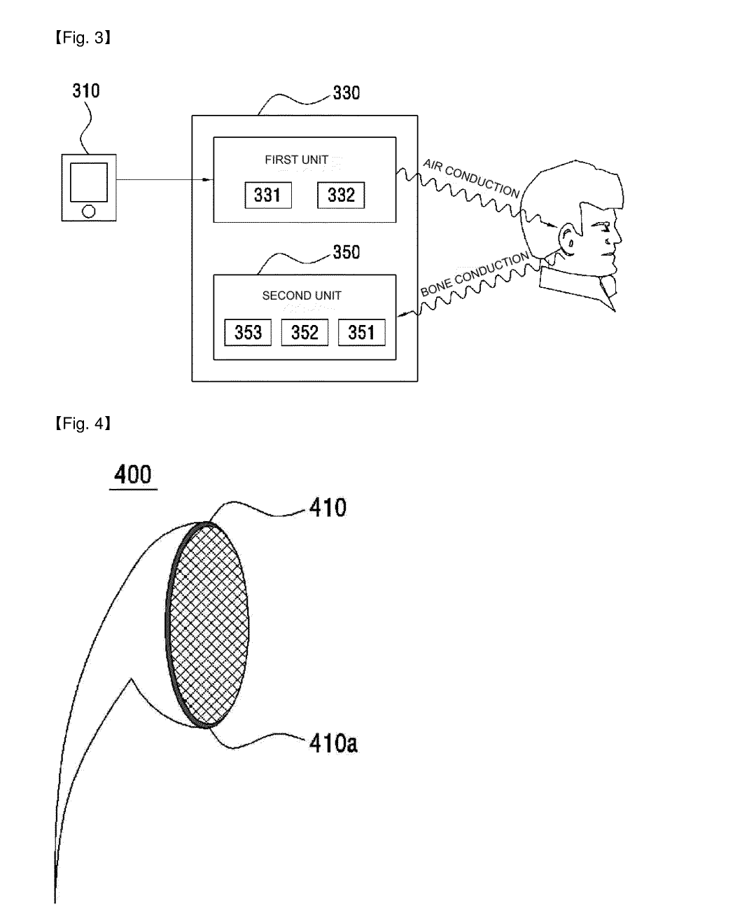

FIG. 3 is a block diagram showing an earphone according to an embodiment of the present disclosure, and FIG. 4 is a schematic view of the earphone.

Referring to FIG. 3, the earphone connectable to a medium device and inserted into the ear of a person according to an embodiment of the present disclosure includes a first unit 330 for generating an air conduction sound in response to an electric signal generated from the medium device 310; and a second unit 350 for detecting a bone conduction sound transmitted through the bone and manipulating the medium device according to a pattern of the transferred bone conduction sound. The first unit 330 generates a sound in the same way as a conventional earphone and thus basically includes a magnet 331 for forming an electric field according to the electric signal from the medium device 310, and a vibration plate 332 such as a diaphragm which vibrates according to the formed electric field. The first unit 330 transfers a sound to a user in the same way as a conventional earphone and is not described in detail here.

Referring to FIG. 3 again, the earphone according to the present disclosure further includes the second unit 350 for detecting bone conduction (sound) generated from a user and manipulating or controlling a medium device connected thereto accordingly, in addition to the first unit 310 described above. In other words, the earphone includes a first function of transferring a sound from the medium device and additionally a second function of manipulating or controlling the medium device in response thereto. In the embodiment of the present disclosure, the second unit 350 includes a sensor 351 for detecting a bone conduction sound generated from the collision of teeth of a user, a calculator 353 for comparing the bone conduction sound pattern detected by the sensor with a preset sound pattern, and a controller 352 for manipulating the connected medium device by generating a command signal allocated to the preset sound pattern, in the case the detected bone conduction sound pattern is determined as the preset sound pattern. In the embodiment depicted in FIG. 3, the number of the second unit 350 is one, but the present disclosure is not limited thereto. For example, the second unit 350 of the present disclosure may have at least one channel. In other words, the second unit 350, namely bone conduction sensors, may be mounted to upper and lower portions of the ear in order to induce an improved bone conduction recognition rate according to patterns of two channels.

The sensor 351 shown in FIG. 3 may be a vibration sensor which detects vibrations transferred through the bone, but the present disclosure is not limited thereto. In addition, the calculator 353 compares the detected bone conduction sound pattern with a previously stored bone conduction sound pattern, and controls the medium device according to a matched bone conduction pattern by using a command signal corresponding thereto. For example, in the case a user makes upper and lower teeth collide twice within a predetermined time, the regeneration of music of the medium device may be stopped according to the bone conduction pattern obtained from the collision of teeth. In addition, in the case strong collision and weak collision of teeth are made sequentially, the medium device may be manipulated to turn down the volume. Therefore, in the present disclosure, the bone conduction pattern may be a combination of various elements. For example, the bone conduction pattern may be determined according to the frequency of bone conduction sounds (the number of collisions), intensity of collisions, location of collisions or the like.

FIG. 4 is a schematic view showing an earphone according to an embodiment of the present disclosure.

Referring to FIG. 4, an earphone 400 according to the present disclosure includes a housing 410 accommodating a vibration plate, a magnet or the like therein, identical to a general earphone. In the present disclosure, the earphone 400 may particularly include a sensor for detecting a sound according to bone conduction vibrations at an outer surface 410a of the housing 410, namely the outer surface 410a actually contacting the inside of the ear of a person. The sensor may be at least one channel, and for example the bone conduction sensors may be mounted to upper and lower portions of the ear to induce an improved bone conduction recognition rate according to patterns of two channels, as described above.

According to another embodiment of the present disclosure, a headphone capable of manipulating or controlling a connected medium device according to bone conduction is provided.

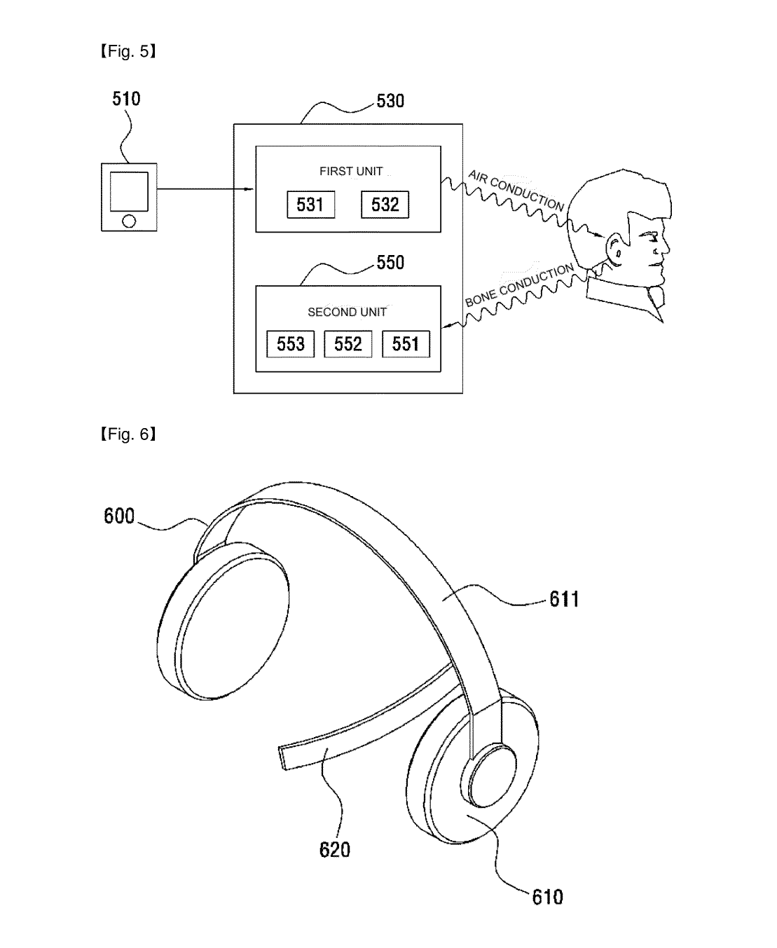

FIG. 5 is a block diagram showing a headphone according to an embodiment of the present disclosure.

Referring to FIG. 5, the headphone includes a first unit 530 for generating an air conduction sound in response to an electric signal generated from a medium device 510, and a second unit 550 for detecting a bone conduction sound transmitted through the bone and manipulating the medium device according to a pattern of the transferred bone conduction sound.

The first unit includes a magnet 531 for forming an electric field according to the electric signal from the medium device, and a vibration plate 532 vibrating according to the formed electric field. This is similar to a general headphone structure and not described in detail here.

The second unit 550 of the headphone according to the present disclosure includes a sensor 551 for detecting a bone conduction sound generated from the collision of teeth of a user, a calculator 552 for comparing the bone conduction sound pattern detected by the sensor with a preset sound pattern, and a controller 553 for manipulating the connected medium device by generating a command signal allocated to the preset sound pattern, in the case the detected bone conduction sound pattern is determined as the preset sound pattern. In other words, the headphone according to the present disclosure searches a pattern matched with the detected bone conduction sound pattern and then manipulates the medium device according to a command signal allocated to the corresponding bone conduction pattern.

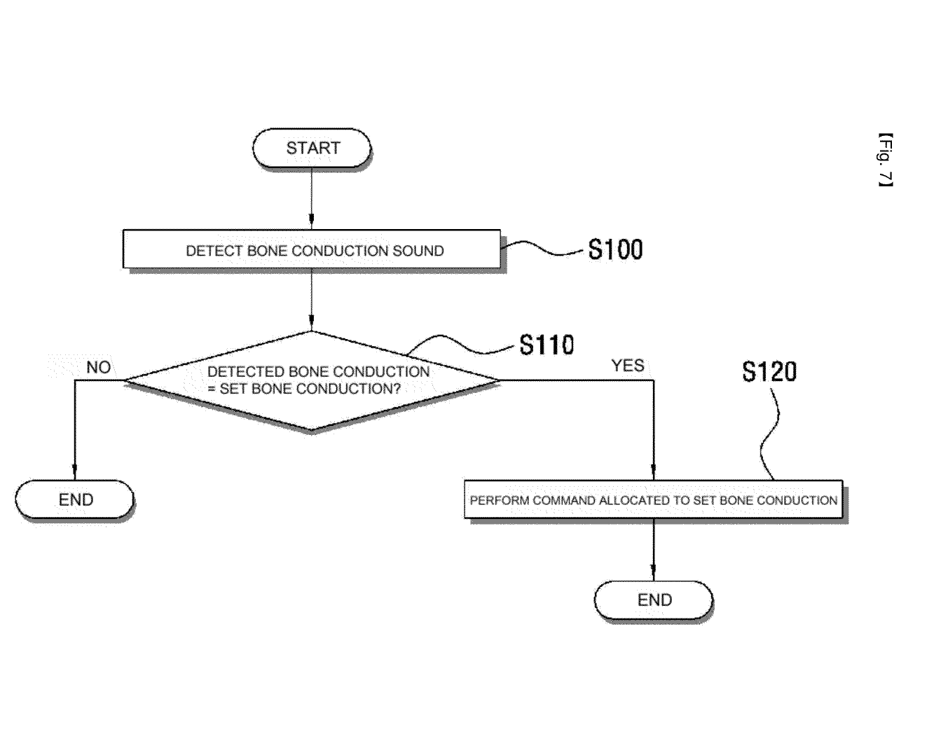

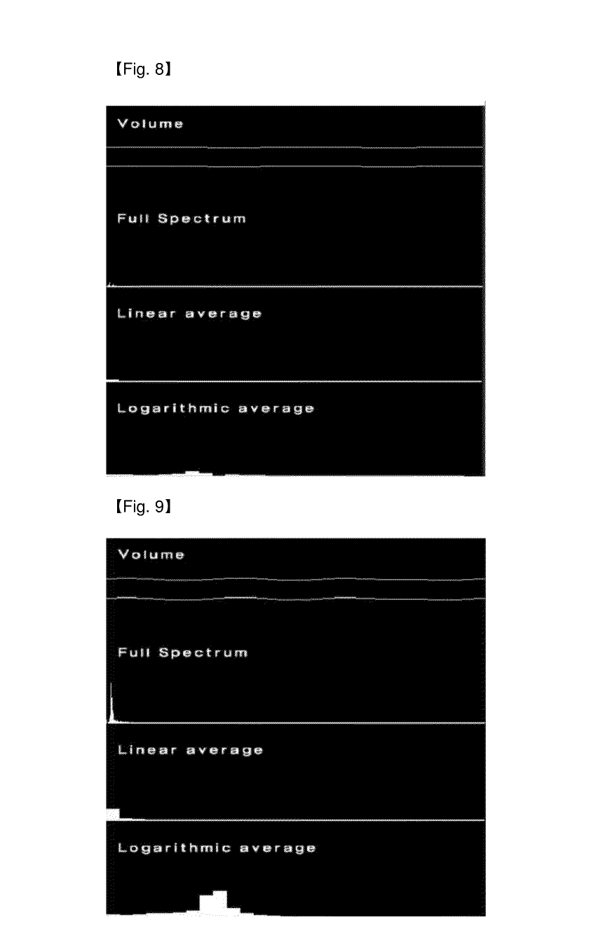

FIG. 6 is a schematic view showing a headphone according to the present disclosure.

Referring to FIG. 6, a headphone 600 includes a second unit 620 separately configured from a first unit 610, and the second unit 620 extends from the headset 611 and has an end configured as an extension member which may directly contacts the cheek or the cheekbone of a user. However, the second unit 620 may also be configured in other ways, and all configurations of the second unit 620 are included in the scope of the present disclosure if it may detect sound vibrations transferred from the bone.

The present disclosure also provides a method for operating a medium device by using an earphone or a headphone, as shown in the flowchart of FIG.

7.

Referring to FIG. 7, first, a bone conduction sound is detected by using a bone conduction sensor provided at the earphone or the headphone (S100). In particular, different from noise caused by various external air conductions, the bone conduction has a peculiar frequency band and is not interfered by external noise caused by air conduction, and so, even though air conduction sound is transferred from the medium device to the user during Operation S100, the detection of bone conduction sound is not interfered. After that, the detected sound pattern is compared with a preset (stored) sound pattern (S110). If the detected bone conduction pattern is different from the stored pattern, a medium device manipulating signal is not generated, but if the detected sound pattern is matched with the preset sound pattern, a command signal allocated to the preset sound pattern is generated (S120). After that, the medium device is manipulated according to the command signal. In the embodiment of the present disclosure, the bone conduction sound pattern is generated from the collision of teeth of the user, and the user wearing a headphone or an earphone may manipulate the medium device connected to the headphone or the earphone by colliding teeth while listening to music.

FIGS. 8 and 9 show a spectrum of a sound exhibited at ordinary conversation and a spectrum of a bone conduction pattern generated from the collision of teeth, respectively. Referring to FIGS. 8 and 9, it may be understood that the bone conduction sensor provided at the face portion may clearly detect bone conduction information to be clearly distinguishable only by using the collision of teeth. The difference in spectrums is generated since the vibration of the vocal cords and the collision of bones bring different conduction phases.

While the present invention has been described with respect to the specific embodiments, it will be apparent to those skilled in the art that various changes and modifications may be made from the present invention. Therefore, the spirit and scope of the invention should be defined in the appended claims.

### INDUSTRIAL APPLICABILITY

The bone conduction-based earphone according to the present disclosure may effectively control a medium device by using a bone conduction sound generated from the collision of teeth while receiving sound information such as music. Therefore, a user may effectively manipulate or control the medium device by using teeth or the like instead of using the hand.

1. A bone conduction-based earphone, comprising:
a bone conduction sensor operable to detect a sound transferred through a bone of a person; and
a controller operable to manipulate a medium device connected to the earphone in response to a pattern of the sound when the sound is detected by the bone conduction sensor.

2. The bone conduction-based earphone according to claim 1, wherein the sound detectable by the bone conduction sensor is a sound from the collision of teeth of a user.

3. The bone conduction-based earphone according to claim 1, wherein the bone conduction sensor has at least two channels to induce an improved recognition rate.

4. The bone conduction-based earphone according to claim 2, further comprising a filtering unit operable to filter frequency bands other than a frequency band of the sound of the collision of teeth.

5. A bone conduction-based headphone, wherein the earphone defined in claim 1 is configured to be worn on a head of a user in a headphone type.

6. An earphone connectable to a medium device and insertable into the ear of a person, the earphone comprising:
a first unit operable to generate an air conduction sound in response to an electric signal generated from the medium device; and
a second unit operable to detect a bone conduction sound transmitted through a bone of a person, the second unit operable to manipulate the medium device according to a pattern of the bone conduction sound.

7. The earphone according to claim 6, wherein the first unit includes:
a magnet operable to form an electric field according to the electric signal from the medium device; and
a vibration plate operable to vibrate according to the electric field.

8. The earphone according to claim 7, wherein the second unit includes:
a sensor operable to detect a bone conduction sound from the collision of teeth of a user;
a calculator operable to compare the bone conduction sound pattern with a preset sound pattern; and
a controller operable to manipulate the connected medium device by generating a command signal allocated to the preset sound pattern, in the case the bone conduction sound pattern is determined as the preset sound pattern.

9. The earphone according to claim 8, wherein the sensor is provided in an earphone housing which allows configured to allow the earphone to contact the ear of a person.

10. The earphone according to claim 8, wherein the earphone is operable to distinguish the bone conduction sound pattern according to a frequency of the collisions of teeth and locations of the collisions.

11. A headphone connectable to a medium device and worn on the head of a person, the headphone comprising:
a first unit operable to generate an air conduction sound in response to an electric signal from the medium device; and
a second unit operable to detect a bone conduction sound transmitted through the bone, the second unit operable to manipulate the medium device according to a pattern of the bone conduction sound.

12. The headphone according to claim 11, wherein the first unit includes:
a magnet operable to form an electric field according to the electric signal; and
a vibration plate operable to vibrate according to the electric field.

13. The headphone according to claim 11, wherein the second unit includes:
a sensor operable to detect a bone conduction sound associated with collision of teeth of a user;
a calculator operable to compare the bone conduction sound pattern with a preset sound pattern; and
a controller operable to manipulate the connected medium device by generating a command signal allocated to the preset sound pattern, in the case the bone conduction sound pattern is determined as the preset sound pattern.

14. A method, the method comprising:
detecting a bone conduction sound pattern by using a bone conduction sensor provided at an earphone or headphone;
comparing the detected bone conduction sound pattern with a preset sound pattern;
generating a command signal allocated to the preset sound pattern, in the case the detected sound pattern is matched with the preset sound pattern; and
manipulating the medium device according to the command signal.

15. The method according to claim 14, wherein the bone conduction sound is generated from the collision of teeth of a user.

16. The bone conduction-based headphone according to claim 1, wherein the sound detectable by the bone conduction sensor comprises a sound from a body of a user.

17. The bone conduction-based headphone according to claim 1, wherein the controller is operable to modify an output characteristic of the medium device.

18. The bone conduction-based headphone according to claim 17, wherein the output characteristic of the medium device comprises an output volume of the medium device.

19. The headphone according to claim 11, wherein the bone conduction sound detectable by the second unit comprises a sound from a body of a user.

20. The headphone according to claim 11, wherein the second unit is operable to modify an output characteristic of the medium device.
